(19) United States
(12) Patent Application Publication
(10) Pub. No.: US 2024/0113331 A1
(43) Pub. Date: Apr. 4, 2024

(54) BATTERY

(71) Applicant: Panasonic Intellectual Property Management Co., Ltd., Osaka (JP)

(72) Inventor: KENTA NAGAMINE, Osaka (JP)

(21) Appl. No.: 18/536,335

(22) Filed: Dec. 12, 2023

Related U.S. Application Data
(63) Continuation of application No. PCT/JP2022/026077, filed on Jun. 29, 2022.

(30) Foreign Application Priority Data
Jul. 9, 2021 (JP) 2021-114612

(51) Int. Cl. H01M 10/0562; H01M 50/119; H01M 50/121; H01M 50/128; H01M 50/129

(52) U.S. Cl. CPC H01M 10/0562; H01M 50/119; H01M 50/121; H01M 50/128; H01M 50/129; H01M 10/0525; H01M 2300/008

(57) ABSTRACT

A battery includes a power generator and a covering body covering the power generator. The power generator includes a positive electrode layer, a negative electrode layer, and a solid electrolyte layer positioned between the positive electrode layer and the negative electrode layer. At least one selected from the group consisting of the positive electrode layer, the solid electrolyte layer, and the negative electrode layer contains a halogen-containing solid electrolyte. The covering body includes a base material layer, a resin layer, and a metal layer positioned between the base material layer and the resin layer. The resin layer is disposed so as to face the power generator and contains a halogen-containing polymer.

### BACKGROUND

### 1. Technical Field

The present disclosure relates to a battery.

### 2. Description of the Related Art

Japanese Unexamined Patent Application Publication No. 2012-164680 discloses a laminate containing aluminum as a battery covering body. Also disclosed is that hydrogen fluoride generated by the decomposition of lithium phosphate hexafluoride, which is a lithium salt contained in a nonaqueous electrolyte secondary battery, corrodes aluminum as a protective layer of the covering body to cause delamination of the covering body. Further disclosed is, as a method for suppressing the delamination, inserting an intermediate layer between the protective layer and an adhesive layer.

### SUMMARY

The present disclosure provides a technique improving battery reliability.

In one general aspect, the techniques disclosed here feature a battery including a power generator and a covering body covering the power generator, wherein the power generator includes a positive electrode layer, a negative electrode layer, and a solid electrolyte layer positioned between the positive electrode layer and the negative electrode layer, at least one selected from the group consisting of the positive electrode layer, the solid electrolyte layer, and the negative electrode layer contains a halogen-containing solid electrolyte, the covering body includes a base material layer, a resin layer, and a metal layer positioned between the base material layer and the resin layer, and the resin layer is disposed so as to face the power generator and contains a halogen-containing polymer.

The present disclosure can improve battery reliability.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram of a schematic configuration of a covering body in a first embodiment;

FIG. 2 is a diagram of a schematic configuration of a battery in the first embodiment;

FIG. 3 is a diagram of a schematic configuration of a covering body in a second embodiment;

FIG. 4 is a diagram of a schematic configuration of a covering body in a third embodiment; and

FIG. 5 is a sectional view of a schematic configuration of an example of a power generating device.

### DETAILED DESCRIPTIONS

### Underlying Knowledge Forming Basis of the Present Disclosure

In nonaqueous electrolyte secondary batteries such as lithium-ion secondary batteries, during a battery charging reaction, the potential of a positive electrode increases up to a high potential, which is 4 V or more higher than that of lithium. Studies by the present inventor have found a phenomenon in which when a halogen-containing solid electrolyte is used as a component material of a solid battery, and charging is performed up to such a high potential, the halogen present in the solid electrolyte as anions is oxidized to be discharged as a halogen gas or a hydrogen halide gas. Such a gas has high corrodibility and easily reacts with metals or organic substances.

Meanwhile, laminates produced by laminating various materials on each other are being widely used as battery covering bodies. Such a laminate includes a base material layer mainly for holding its shape, a protective layer for suppressing the entry of water or oxygen, and an adhesive layer for thermally bonding, when a plurality of laminates are laminated on each other, the laminates together. Nylon, aluminum, and a polyolefin resin are used for the base material layer, the protective layer, and the adhesive layer, respectively.

Japanese Unexamined Patent Application Publication No. 2012-164680 discloses that the decomposition of a lithium salt in an electrolyte produces hydrogen fluoride, thereby corroding the materials in the laminate. Also disclosed is, as a measure against the phenomenon, disposing an intermediate layer for suppressing corrosion by hydrofluoric acid between the protective layer and the adhesive layer. Japanese Unexamined Patent Application Publication No. 2012-164680 also discloses providing a protective layer formed of resin such as an epoxy resin on the surface of the innermost layer side of a barrier layer to absorb and/or adsorb hydrogen fluoride.

However, although the configuration disclosed in Japanese Unexamined Patent Application Publication No. 2012-164680 suppresses the corrosion of aluminum in the protective layer to be able to protect the delamination of the adhesive layer, studies by the present inventor have found a problem in that the corrosion of the adhesive layer itself cannot be suppressed.

The corrosive gas produced in the solid battery remains as gas inside a container formed of the laminate in high concentrations and thus causes a reaction with the polyolefin resin as the adhesive layer to markedly reduce the flexibility of the adhesive layer. When the reaction further proceeds, the adhesive layer is destroyed, and at the same time, the internal protective layer is also corroded by the corrosive gas and is destroyed. Consequently, the laminate cannot hold insulating properties or gas barrier properties as a battery covering body and becomes unable to ensure battery reliability.

The present disclosure has been made in view of the above problem, and an object thereof is to improve battery reliability.

### Summary of Aspects According to Present Disclosure

A battery according to a first aspect of the present disclosure includes:
a power generator; and
a covering body covering the power generator, wherein
the power generator includes:
   a positive electrode layer;
   a negative electrode layer; and
   a solid electrolyte layer positioned between the positive electrode layer and the negative electrode layer,
at least one selected from the group consisting of the positive electrode layer, the solid electrolyte layer, and the negative electrode layer contains a halogen-containing solid electrolyte,
the covering body includes:
   a base material layer;
   a resin layer; and
   a metal layer positioned between the base material layer and the resin layer, and
   the resin layer is disposed so as to face the power generator and contains a halogen-containing polymer.

According to the first aspect, direct contact between a corrosive gas and a layer of the covering body having insulating properties or gas barrier properties can be suppressed. Consequently, battery reliability can be improved.

In a second aspect of the present disclosure, for example, in the battery according to the first aspect, the metal layer may contain at least one selected from the group consisting of aluminum, an aluminum alloy, and stainless steel.

In a third aspect of the present disclosure, for example, in the battery according to the first aspect, the metal layer may contain aluminum.

In a fourth aspect of the present disclosure, for example, in the battery according to any one of the first to third aspects, an ion radius of halogen contained in the resin layer may be equal to or smaller than an ion radius of halogen contained in the solid electrolyte.

In a fifth aspect of the present disclosure, for example, the battery according to any one of the first to fourth aspects may further include a primer layer positioned between the metal layer and the resin layer.

In a sixth aspect of the present disclosure, for example, in the battery according to the fifth aspect, the primer layer may contain at least one selected from the group consisting of nitrogen, silicon, sulfur, and titanium.

In a seventh aspect of the present disclosure, for example, in the battery according to the fifth aspect, the primer layer may contain at least one selected from the group consisting of a silane coupling agent, a titanate coupling agent, polyimide, polyimide, and a polymer having a sulfonic acid group.

In an eighth aspect of the present disclosure, for example, in the battery according to any one of the first to seventh aspects, the resin layer may further contain a polymer containing no halogen.

In a ninth aspect of the present disclosure, for example, in the battery according to any one of the first to eighth aspects, the halogen-containing polymer may be a polymer containing fluorine atoms or chlorine atoms.

In a 10th aspect of the present disclosure, for example, in the battery according to the ninth aspect, the halogen-containing polymer may be a fluorine-containing polymer, and the fluorine-containing polymer may contain at least one selected from the group consisting of tetrafluoroethylene, vinylidene fluoride, perfluoroalkyl vinyl ether, hexafluoropropylene, and chlorotrifluoroethylene.

In an 11th aspect of the present disclosure, for example, in the battery according to the ninth aspect, the halogen-containing polymer may be a fluorine-containing polymer, and the fluorine-containing polymer may contain at least one selected from the group consisting of tetrafluoroethylene, vinylidene fluoride, and hexafluoropropylene.

In a 12th aspect of the present disclosure, for example, in the battery according to the ninth aspect, the halogen-containing polymer may be a fluorine-containing polymer, and the fluorine-containing polymer may contain at least one selected from the group consisting of fluorinated polyethylene, fluorinated polypropylene, poly(tetrafluoroethylene-co-hexafluoropropylene), polytetrafluoroethylene, polyvinylidene fluoride, polyvinyl fluoride, polychlorotrifluoroethylene, a fluorine rubber, a fluorosilicone rubber, poly(vinylidene fluoride-co-hexafluoropropylene), poly(vinylidene fluoride-co-hexafluoropropylene-co-tetrafluoroethylene), a tetrafluoroethylene-propylene rubber, and a tetrafluoroethylene-perfluoromethylvinyl ether rubber.

In a 13th aspect of the present disclosure, for example, in the battery according to any one of the first to 12th aspects, a concentration of halogen of the resin layer may become higher continuously or in stages from a side facing the metal layer toward a side facing away from the metal layer.

According to the second to 13th aspects, direct contact between a corrosive gas and a layer of the covering body having insulating properties or gas barrier properties can be suppressed. Consequently, battery reliability can be improved.

A battery covering body according to a 14th aspect of the present disclosure includes:
a base material layer;
a resin layer; and
a metal layer positioned between the base material layer and the resin layer, wherein the resin layer contains a halogen-containing polymer.

In a 15th aspect of the present disclosure, for example, the battery covering body according to the 14th aspect may further include a primer layer positioned between the metal layer and the resin layer.

In a 16th aspect of the present disclosure, for example, in the battery covering body according to the 14th or 15th aspect, the metal layer may contain aluminum.

In a 17th aspect of the present disclosure, for example, in the battery covering body according to any one of the 14th to 16th aspects, the halogen-containing polymer may be a polymer containing fluorine atoms or chlorine atoms.

In an 18th aspect of the present disclosure, for example, in the battery covering body according to the 17th aspect, the halogen-containing polymer may be a fluorine-containing polymer, and the fluorine-containing polymer my contain at least one selected from the group consisting of tetrafluoroethylene, vinylidene fluoride, perfluoroalkyl vinyl ether, hexafluoropropylene, and chlorotrifluoroethylene.

In a 19th aspect of the present disclosure, for example, in the battery covering body according to the 17th aspect, the halogen-containing polymer may be a fluorine-containing polymer, and the fluorine-containing polymer may contain at least one selected from the group consisting of tetrafluoroethylene, vinylidene fluoride, and hexafluoropropylene.

In a 20th aspect of the present disclosure, for example, in the battery covering body according to the 17th aspect, the halogen-containing polymer may be a fluorine-containing polymer, and the fluorine-containing polymer may contain at least one selected from the group consisting of fluorinated polyethylene, fluorinated polypropylene, poly(tetrafluoroethylene-co-hexafluoropropylene), polytetrafluoroethylene, polyvinylidene fluoride, polyvinyl fluoride, polychlorotrifluoroethylene, a fluorosilicone rubber, poly(vinylidene fluoride-co-hexafluoropropylene), poly(vinylidene fluoride-co-hexafluoropropylene-co-tetrafluoroethylene), a tetrafluoroethylene-propylene rubber, and a tetrafluoroethylene-perfluoromethylvinyl ether rubber.

According to the 14th to 20th aspects, when being used for a battery, direct contact between a corrosive gas inside the battery and a layer of the covering body having insulating properties or gas barrier properties can be suppressed. Consequently, the covering body according to the present disclosure can improve battery reliability.

The following describes embodiments of the present disclosure with reference to the accompanying drawings. The present disclosure is not limited by the following embodiments.

### EMBODIMENTS

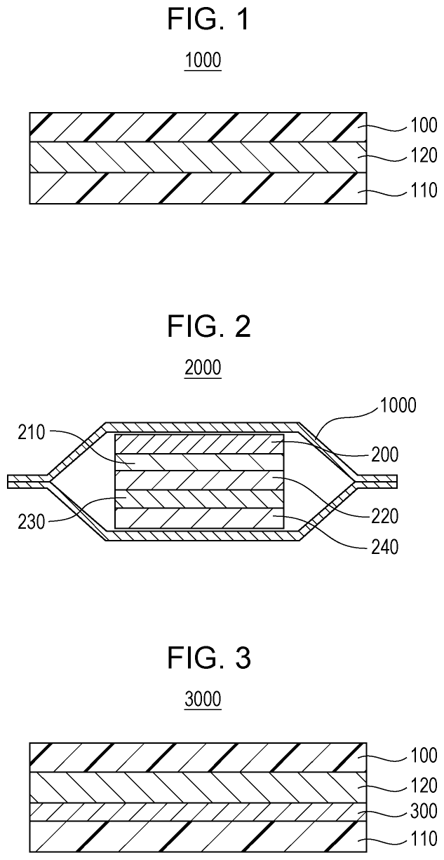

FIG. 1 is a sectional view of a schematic configuration of a covering body 1000 in a first embodiment.

The covering body 1000 in the first embodiment includes a base material layer 100, a resin layer 110, and a metal layer 120 positioned between the base material layer 100 and the resin layer 110. The resin layer 110 contains a halogen-containing polymer. The resin layer 110 is disposed so as to face a power generator of a battery. The resin layer 110 is a layer containing resin. The resin layer 110 contains a halogen-containing polymer.

The material of the base material layer 100 may be a polyester resin, a nylon resin, or the like. The material of the polyester resin and the nylon resin may be oriented. The polyester resin may be polyethylene terephthalate, polybutylene terephthalate, polyethylene naphthalate, polybutylene naphthalate, a copolymerized polyester, polycarbonate, or the like. The nylon resin may be a polyimide resin such as Nylon 6, Nylon 6,6, a copolymer of Nylon 6,6 and Nylon 6, Nylon 6,10, or poly(m-xylylene adipamide) (MXD6). The thickness of the base material layer 100 may be larger than or equal to 5 μm and smaller than or equal to 40 μm.

The halogen-containing polymer contains halogen atoms in its structure. The halogen atoms that the halogen-containing polymer contains may be fluorine atoms, chlorine atoms, bromine atoms, iodine atoms, or the like. The halogen-containing polymer contained in the resin layer 110 may be a polymer containing fluorine atoms or chlorine atoms. The ion radius of the halogen contained in the resin layer 110 may be equal to or smaller than the ion radius of the halogen contained in a solid electrolyte.

With the above configuration, the corrosion of the metal layer 120 by a corrosive gas can be suppressed more effectively. A halide ion having a smaller ion radius makes its electronegativity larger and makes its bonding to carbon in a polymer chain stronger. That is, when the ion radius of the halide ion contained in the resin layer 110 is smaller than the ion radius of the halide ion contained in the produced corrosive gas, the halide ion in the corrosive gas is hard to cause a reaction with the polymer of the resin layer 110. When the ion radii are the same, that is, they are the same element also, reaction driving force is small, thus making it hard to cause a reaction.

The metal layer 120 may contain at least one metal element selected from the group consisting of aluminum and iron. The metal layer 120 may contain at least one selected from aluminum, an aluminum alloy, and stainless steel. The aluminum alloy may be an alloy with aluminum contained as a main component. The metal layer 120 may contain aluminum. With the above configuration, sufficient strength, lightness in weight, and economy as the covering body 1000 of a battery can be achieved. The thickness of the metal layer 120 may be larger than or equal to 5 μm and smaller than or equal to 40 μm. The metal layer 120 is typically formed of a metallic foil.

The halogen-containing polymer in the structure of the covering body 1000 has a higher softening point than that of a polymer containing no halogen and is a material harder at room temperature. For this reason, if the resin layer 110 is present inside the metal layer 120, that is, present so as to face the power generator of the battery, when a plurality of covering bodies 1000 are laminated on each other, adhesion between the covering bodies 1000 is hindered. In the resin layer 110, the concentration of the halogen may become higher continuously or in stages from a side facing the metal layer 120 toward a side facing away from the metal layer 120. The concentration of the halogen means the amount of a halogen element contained in the resin layer 110. As the method for measuring the amount of the halogen element, using a glow discharge emission analyzer, elemental analysis may be performed from the surface direction toward the depth direction.

FIG. 2 is a diagram of a schematic configuration of a battery 2000 in the first embodiment.

The battery 2000 in the first embodiment includes the covering body 1000, a positive electrode collector 200, a positive electrode layer 210, a solid electrolyte layer 220, a negative electrode layer 230, and a negative electrode collector 240. The solid electrolyte layer 220 is disposed between the positive electrode layer 210 and the negative electrode layer 230. The positive electrode layer 210 is a layer containing a positive electrode active material. The negative electrode layer 230 is a layer containing a negative electrode active material. The positive electrode layer 210, the solid electrolyte layer 220, and the negative electrode layer 230 form a power generator of the battery 2000. At least one selected from the group consisting of the positive electrode layer 210, the solid electrolyte layer 220, and the negative electrode layer 230 contains a halogen-containing solid electrolyte. The halogen-containing solid electrolyte may be a halide solid electrolyte or a halogen-containing sulfide solid electrolyte. The positive electrode collector 200 and the negative electrode collector 240 are electrically in contact with the positive electrode layer 210 and the negative electrode layer 230, respectively. The covering body 1000 forms a container of the battery 2000. Specifically, in FIG. 2, the resin layer 110 of the upper covering body 1000 and the resin layer 110 of the lower covering body 1000 are faced each other so as to face each other through their ends and are thermally pressure-bonded together to form the container of the battery 2000. The power generator of the battery 2000 is housed inside the container formed by the covering bodies 1000. With this structure, the power generator of the battery 2000 is covered with the covering bodies 1000.

With the above configuration, a battery with high reliability can be achieved. Disposing the resin layer 110 so as to face the power generator can reduce contact between the corrosive gas produced during battery charging and the metal layer 120 and thus inhibit the deterioration of the metal layer 120. In the present embodiment, the resin layer 110 is in contact with an atmosphere inside the container formed by the covering bodies 1000.

FIG. 3 is a diagram of a schematic configuration of a covering body 3000 in a second embodiment. With the covering body 3000, a battery container similar to that in FIG. 2 (the first embodiment) can be formed. For points with no special descriptions, they may be the same as those of the first embodiment.

The covering body 3000 in the second embodiment includes the base material layer 100, the resin layer 110, the metal layer 120 positioned between the base material layer 100 and the resin layer 110, and a primer layer 300 positioned between the metal layer 120 and the resin layer 110. The resin layer 110 contains a halogen-containing polymer.

With the above configuration, adhesion between the resin layer 110 and the metal layer 120 can be improved, and thus battery reliability can be further improved.

The halogen-containing polymer, especially a fluorine-containing polymer has excellent chemical durability but has small interaction with other substances. For this reason, such a polymer is hard to adhere to different types of materials such as metal and ceramic. Given these circumstances, disposing a primer layer as a layer having high adhesion with both materials can improve adhesion. The primer layer is desirably disposed uniformly in the plane direction without pinholes.

The primer layer 300 may contain at least one selected from the group consisting of nitrogen, silicon, sulfur, and titanium. With the above configuration, adhesion between the resin layer 110 and the metal layer 120 can be improved, and thus battery reliability can be further improved. These elements can form bonding connecting inorganic materials and organic materials to each other and can thus improve adhesion.

The primer layer 300 may contain at least one selected from the group consisting of a silane coupling agent, a titanate coupling agent, polyimide, polyamide, and a polymer having a sulfonic acid group. The thickness of the primer layer 300 may be larger than or equal to 10 nm and smaller than or equal to 10 μm. With the above configuration, adhesion between the resin layer 110 and the metal layer 120 can be improved, and thus battery reliability can be further improved.

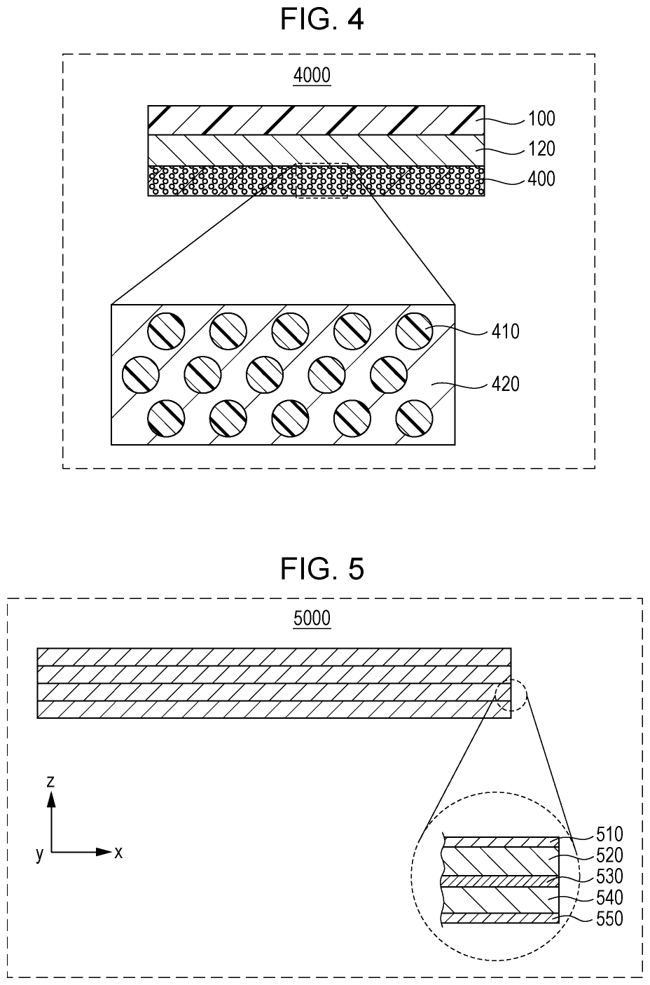

FIG. 4 is a diagram of a schematic configuration of a covering body 4000 in a third embodiment. With the covering body 4000, a battery container similar to that in FIG. 2 (the first embodiment) can be formed. For points with no special descriptions, they may be the same as those of the first embodiment.

The covering body 4000 in the third embodiment includes the base material layer 100, a resin layer 400, and the metal layer 120 positioned between the base material layer 100 and the resin layer 400. The resin layer 400 contains a polymer 410 containing no halogen and a halogen-containing polymer 420.

With the above configuration, when a plurality of covering bodies are laminated on each other, adhesion between the covering bodies can be improved, and thus battery reliability can be further improved.

The halogen-containing polymer 420 has a high melting point and a high softening point, has small interaction with other materials, and thus makes it relatively hard to join the covering bodies together when the covering bodies are laminated on each other. Given these circumstances, by disposing a polymer having not only the halogen-containing polymer 420 but also the polymer 410 containing no halogen in the resin layer 400, the polymer 410 containing no halogen, which has a lower softening point, is melted when the covering bodies are thermally bonded together, and thus adhesion can be improved. Such a configuration can achieve both adhesion and chemical durability. The halogen-containing polymer 420 having a larger volume ratio more improves chemical durability, whereas the polymer 410 containing no halogen having a larger volume ratio more improves adhesion.

The polymer 410 containing no halogen may be a thermoplastic resin or a thermosetting resin.

The thermoplastic resin may be, for example, a polyolefin resin, an acrylic resin, a polystyrene resin, a vinyl chloride resin, a silicone resin, a polyimide resin, a polyimide resin, a fluorinated hydrocarbon resin, a polyether resin, rubber, or the like. The polyolefin resin may be a polyethylene resin, a polypropylene resin, or the like. The rubber may be a butadiene rubber, an isoprene rubber, a styrene-butadiene rubber (SBR), poly(styrene-co-butadiene-co-styrene) (SBS), poly(styrene-co-ethylene-co-butadiene-co-styrene) (SEBS), an ethylene-propylene rubber, a butyl rubber, a chloroprene rubber, an acrylonitrile-butadiene rubber, or the like. The thermosetting resin may be a urethane resin, an epoxy resin, or the like. The resin may be used alone, or two or more may be used in combination. With the above configuration, both resistance to the corrosive gas and the adhesion of the covering body 4000 can be achieved.

The shape or structure of the material of each of the polymer 410 containing no halogen and the halogen-containing polymer 420 is not particularly limited; particles formed of the polymer 410 containing no halogen may be dispersed in the halogen-containing polymer 420 or they may have a structure in which they randomly mix together.

The following describes a specific example of the resin layer 110 of the covering bodies in the first and second embodiments and the resin layer 400 of the covering body in the third embodiment. The resin layers 110 and 400 contain a halogen-containing polymer. The halogen-containing polymer may be a polymer resin containing fluorine atoms or chlorine atoms. With the above configuration, resistance to the corrosive gas can be achieved.

The fluorine-containing polymer may contain at least one selected from the group consisting of tetrafluoroethylene (TFE), vinylidene fluoride, perfluoroalkyl vinyl ether, hexafluoropropylene (HFP), and chlorotrifluoroethylene. With the above configuration, both resistance to the corrosive gas and moldability can be achieved.

The fluorine-containing polymer may contain at least one selected from the group consisting of tetrafluoroethylene, vinylidene fluoride, and hexafluoropropylene. With the above configuration, both resistance to the corrosive gas and moldability can be achieved.

The fluorine-containing polymer may contain a fluorine rubber. The fluorine rubber may be a fluorosilicone rubber, poly(vinylidene fluoride-co-hexafluoropropylene) (FKM), poly(vinylidene fluoride-co-hexafluoropropylene-co-tetrafluoroethylene), a tetrafluoroethylene-propylene rubber (FEPM), a tetrafluoroethylene-perfluoromethylvinyl ether rubber (FFKM), or the like. The fluorine-containing polymer may contain at least one selected from the group consisting of fluorinated polyethylene, fluorinated polypropylene, poly(tetrafluoroethylene-co-hexafluoropropylene) (FEP), polytetrafluoroethylene (PTFE), polyvinylidene fluoride (PVDF), polyvinyl fluoride (PVF), polychlorotrifluoroethylene (PCTFE), a fluorine rubber, a fluorosilicone rubber, poly(vinylidene fluoride-co-hexafluoropropylene), poly(vinylidene fluoride-co-hexafluoropropylene-co-tetrafluoroethylene), a tetrafluoroethylene-propylene rubber (FEPM), and a tetrafluoroethylene-perfluoromethylvinyl ether rubber (FFKM). With this configuration, resistance to the corrosive gas can be achieved.

The resin layers 110 and 400 are formed by subjecting the metal layer 120 to surface modification. With the above configuration, both resistance to the corrosive gas and moldability can be achieved. The resin layers 110 and 400 may be formed, during production of the covering body 4000, by bringing a halogen-containing gas such as a fluorine gas, a hydrogen fluoride gas, a chlorine gas, or a hydrogen chloride gas into contact with the surface of the covering body 4000 to introduce fluorine or chlorine into the polymer on the surface of the metal layer 120. The surface of the metal layer 120 may be modified by immersing the covering body 4000 into a solution containing at least one selected from the group consisting of fluoride ions and chloride ions.

The resin layers 110 and 400 have a structure in which the concentration of the halogen becomes higher continuously or in stages from a side facing the metal layer 120 toward a side facing away from the metal layer 120. With the above configuration, both resistance to the corrosive gas and moldability can be achieved. The thickness of the resin layers 110 and 400 may be larger than or equal to 1 nm and smaller than or equal to 10,000 nm.

The following describes a specific example of a power generating device 5000 when a battery including a covering body selected from the group consisting of the covering bodies of the first to third embodiments is formed. The battery includes the power generating device 5000 and the covering body selected from the group consisting of the covering bodies of the first to third embodiments covering the power generating device 5000.

The area of a principal face of the power generating device 5000 may be, for example, larger than or equal to 1 cm 2 and smaller than or equal to 100 cm 2 as a battery for portable electronic devices such as smartphones and digital cameras. Alternatively, the area of the principal face of the power generating device 5000 may be larger than or equal to 100 cm 2 and smaller than or equal to 1,000 cm 2 as a battery for power supplies of large-sized mobile devices such as electric vehicles.

FIG. 5 is a sectional view of a schematic configuration of an example of the power generating device 5000.

The power generating device 5000 includes a positive electrode layer 520, a negative electrode layer 540, and an electrolyte layer 530.

The electrolyte layer 530 is disposed between the positive electrode layer 520 and the negative electrode layer 540. In this configuration, the electrolyte layer 530 may be a solid electrolyte layer containing a solid electrolyte. At least one selected from the group consisting of the positive electrode layer 520, the electrolyte layer 530, and the negative electrode layer 540 contains a halogen-containing solid electrolyte. The halogen-containing solid electrolyte may be a halide solid electrolyte or a halogen-containing sulfide solid electrolyte.

With the above configuration, the battery can be formed as a solid battery. The solid battery may be, for example, a storage battery such as an all-solid lithium-ion secondary battery.

The power generating device 5000 may further include a positive electrode collector 510 and a negative electrode collector 550.

The positive electrode collector 510 is disposed in contact with the positive electrode layer 520.

Part of the positive electrode collector 510 may be exposed as a positive electrode terminal outside the covering body 1000.

The negative electrode collector 550 is disposed in contact with the negative electrode layer 540.

Part of the negative electrode collector 550 may be exposed as a negative electrode terminal outside the covering body 1000.

As described above, as illustrated in FIG. 5, the power generating device 5000 may be one power generating element (a single battery cell).

Examples of the positive electrode collector 510 include porous or poreless sheets and films formed of a metallic material such as aluminum, stainless steel, titanium, or alloys thereof. Aluminum and alloys thereof are low-priced and easy to make into a thin film. The sheet or film may be a metallic foil, a mesh, or the like. The thickness of the positive electrode collector 510 may be larger than or equal to 1 μm and smaller than or equal to 30 μm. When the thickness of the positive electrode collector 510 is larger than or equal to 1 μm, mechanical strength can be sufficiently ensured. When the thickness of the positive electrode collector 510 is smaller than or equal to 30 μm, battery energy density can be sufficiently ensured.

The positive electrode layer 520 is a layer containing a positive electrode active material. The positive electrode layer 520 may contain a solid electrolyte. The solid electrolyte of the positive electrode layer 520 may contain a halogen-containing solid electrolyte. The halogen-containing solid electrolyte may be a halide solid electrolyte or a halogen-containing sulfide solid electrolyte.

Examples of the positive electrode active material include lithium-containing transition metal oxides, transition metal fluorides, polyanion and fluorinated polyanion materials, transition metal sulfides, transition metal oxyfluorides, transition metal oxysulfides, and transition metal oxynitrides. When a lithium-containing transition metal oxide is used as positive electrode active material particles in particular, production costs can be reduced and average discharge voltage can be increased. As the lithium-containing transition metal oxide, Li(Ni,Co,Al)O₂ is particularly preferably used. When Li(Ni,Co,Al)O₂ is used, battery energy density can be further increased.

The halide solid electrolyte is represented by, for example, Formula (1) below. In Formula (1), α, β, and γ are each independently a value larger than 0. M includes at least one element selected from the group consisting of metal elements and semi-metal elements other than Li. X includes at least one selected from the group consisting of F, Cl, Br, and I.

Li_{α}M_{β}X_{γ} (1)

The semi-metal elements include B, Si, Ge, As, Sb, and Te. The metal elements include all the elements included in Group 1 to Group 12 of the periodic table except hydrogen and all the elements included in Group 13 to Group 16 except B, Si, Ge, As, Sb, Te, C, N, P, O, S, and Se. The metal elements are an element group that can be cations when forming inorganic compounds with halogen compounds.

Examples of the halide solid electrolyte include Li₃YX₆, Li₂MgX₄, Li₂FeX₄, Li(Al,Ga,In)X₄, and Li₃(Al,Ga,In)X₆. “(Al,Ga,In)” has the same meaning as “at least one selected from the group consisting of Al, Ga, and In.” The representative composition of Li₃YX₆ is Li₃YBr₂Cl₄.

The thickness of the positive electrode layer 520 may be larger than or equal to 10 μm and smaller than or equal to 500 μm. When the thickness of the positive electrode layer 520 is larger than or equal to 10 μm, sufficient battery energy density can be ensured. When the thickness of the positive electrode layer 520 is smaller than or equal to 500 μm, battery operation with high output can be made possible.

The electrolyte layer 530 is, for example, a solid electrolyte layer containing a solid electrolyte. The solid electrolyte may be, for example, a halogen-containing solid electrolyte. The solid electrolyte may contain the halide solid electrolyte described above. The solid electrolyte may contain a sulfide solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂Si₂. To these, LiX (X: F, Cl, Br, I), Li₂O, MO_{z}, Li_{y}MO_{z} (M: any of P, Si, Ge, B, Al, Ga, In, Fe, and Zn) (y, z: a natural number), or the like may be added. As the halogen-containing sulfide solid electrolyte, for example, LiX (X: F, Cl, Br, I) may be added to Li₂S—P₂S₅, Li₂S—SiS₂, Li₂S—B₂S₃, Li₂S—GeS₂, Li_{3.25}Ge_{0.25}P_{0.75}S₄, Li₁₀GeP₂Si₂, or the like. Li₂S—P₂S₅ has high ion conductivity and is hard to reduce at low potential. For this reason, using Li₂S—P₂S₅ makes a battery made easily.

The thickness of the electrolyte layer 530 may be larger than or equal to 1 μm and smaller than or equal to 100 μm. When the thickness of the electrolyte layer 530 is larger than or equal to 1 μm, the positive electrode layer 520 and the negative electrode layer 540 can be surely insulated from each other. When the thickness of the electrolyte layer 530 is smaller than or equal to 100 μm, battery operation with high output can be made possible.

The negative electrode layer 540 is a layer containing a negative electrode active material. The negative electrode layer 540 may contain a solid electrolyte. The solid electrolyte of the negative electrode layer 540 may contain a halogen-containing solid electrolyte. The halogen-containing solid electrolyte may be a halide solid electrolyte or a halogen-containing sulfide solid electrolyte.

The negative electrode active material may be, for example, a material occluding and releasing metal ions. The negative electrode active material may be, for example, a material occluding and releasing lithium ions. Examples of the negative electrode active material include metal lithium, metals or alloys showing alloying reactions with lithium, carbon, transition metal oxides, and transition metal sulfides. Examples of the carbon include graphite and non-graphite carbon such as hard carbon and cokes. Examples of the transition metal oxides include CuO and NiO. Examples of the transition metal sulfides include copper sulfide represented by CuS. Examples of the metals or alloys showing alloying reactions with lithium include silicon compounds, tin compounds, and aluminum compounds, and alloys of these with lithium. When the carbon is used, production costs can be reduced and average discharge voltage can be increased.

The thickness of the negative electrode layer 540 may be larger than or equal to 10 μm and smaller than or equal to 500 μm. When the thickness of the negative electrode layer 540 is larger than or equal to 10 μm, sufficient battery energy density can be ensured. When the thickness of the negative electrode layer 540 is smaller than or equal to 500 μm, battery operation with high output can be made possible.

Examples of the negative electrode collector 550 include porous or poreless sheets and films formed of a metallic material such as stainless steel, nickel, copper, or alloys thereof. Copper and alloys thereof are low-priced and are easy to make into a thin film. The sheet or film may be a metallic foil, a mesh, or the like. The thickness of the negative electrode collector 550 may be larger than or equal to 1 μm and smaller than or equal to 30 μm. When the thickness of the negative electrode collector 550 is larger than or equal to 1 μm, mechanical strength can be sufficiently ensured. When the thickness of the negative electrode collector 550 is smaller than or equal to 30 μm, battery energy density can be sufficiently ensured.

At least one selected from the group consisting of the positive electrode layer 520, the electrolyte layer 530, and the negative electrode layer 540 may contain an oxide solid electrolyte for the purpose of enhancing ion conductivity. Examples of the oxide solid electrolyte include NASICON type solid electrolytes represented by LiTi₂(PO₄)₃ and element substitutes thereof, (LaLi)TiO₃-based perovskite type solid electrolytes, LISICON type solid electrolytes represented by Li₁₄ZnGe₄O₁₆, Li₄SiO₄, LiGeO₄, and element substitutes thereof, garnet type solid electrolytes represented by Li₇La₃Zr₂O₁₂ and element substitutes thereof, Li₃N and H substitutes thereof, and Li₃PO₄ and N substitutes thereof.

At least one selected from the group consisting of the positive electrode layer 520, the electrolyte layer 530, and the negative electrode layer 540 may contain an organic polymer solid electrolyte for the purpose of enhancing ion conductivity. Examples of the organic polymer solid electrolyte include compounds of a polymer compound and a lithium salt. The polymer compound may have an ethylene oxide bond. Having the ethylene oxide bond can contain the lithium salt in a large amount and can further improve ion conductivity. Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. As the lithium salt, one lithium salt selected from these can be used alone. Alternatively, as the lithium salt, a mixture of two or more lithium salts selected from these can be used.

At least one selected from the group consisting of the positive electrode layer 520, the electrolyte layer 530, and the negative electrode layer 540 may contain a nonaqueous electrolyte, a gel electrolyte, or an ionic liquid for the purpose of facilitating transfer of lithium ions and improving battery output characteristics. The nonaqueous electrolyte contains a nonaqueous solvent and a lithium salt dissolved in the nonaqueous solvent. Examples of the nonaqueous solvent include cyclic carbonate solvents, chain-like carbonate solvents, cyclic ether solvents, chain-like ether solvents, cyclic ester solvents, chain-like ester solvents, and fluorine solvents. Examples of the cyclic carbonate solvents include ethylene carbonate, propylene carbonate, and butylene carbonate. Examples of the chain-like carbonate solvents include dimethyl carbonate, ethylmethyl carbonate, and diethyl carbonate. Examples of the cyclic ether solvents include tetrahydrofuran, 1,4-dioxane, and 1,3-dioxolane. Examples of the chain-like ether solvents include 1,2-dimethoxyethane and 1,2-diethoxyethane. Examples of the cyclic ester solvents include γ-butyrolactone. Examples of the chain-like ester solvents include methyl acetate. Examples of the fluorine solvents include fluoroethylene carbonate, fluoromethyl propionate, fluorobenzene, fluoroethylmethyl carbonate, and fluorodimethylene carbonate. As the nonaqueous solvent, one nonaqueous solvent selected from these can be used alone. Alternatively, as the nonaqueous solvent, a combination of two or more nonaqueous solvents selected from these can be used. The nonaqueous electrolyte may contain at least one fluorine solvent selected from the group consisting of fluoroethylene carbonate, fluoromethyl propionate, fluorobenzene, fluoroethylmethyl carbonate, and fluorodimethylene carbonate. Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. As the lithium salt, one lithium salt selected from these can be used alone. Alternatively, as the lithium salt, a mixture of two or more lithium salts selected from these can be used. The concentration of the lithium salt is, for example, in a range of higher than or equal to 0.5 mol/L and lower than or equal to 2 mol/L.

For the gel electrolyte, a product obtained by soaking a polymer material in a nonaqueous electrolyte can be used. Examples of the polymer material include polyethylene oxide, polyacrylonitrile, polyvinylidene fluoride, polymethyl methacrylate, and polymers having an ethylene oxide bond.

Cations forming the ionic liquid may be aliphatic chain-like quaternary salts such as tetraalkylammonium and tetraalkylsulfonium; aliphatic cyclic ammoniums such as pyrrolidiniums, morpholiniums, imidazoliniums, tetrahydropyrimidiniums, piperaziniums, and piperidiniums; nitrogen-containing heterocyclic aromatic cations such as pyridiniums and imidazoliums; or the like. Anions forming the ionic liquid may be PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, C(SO₂CF₃)₃⁻, or the like. The ionic liquid may contain lithium salts.

At least one selected from the group consisting of the positive electrode layer 520, the electrolyte layer 530, and the negative electrode layer 540 may contain a binder for the purpose of improving adhesion between particles. The binder is used in order to improve the bindability of the materials forming electrodes. Examples of the binder include polyvinylidene fluoride, polytetrafluoroethylene, polyethylene, polypropylene, an aramid resin, polyimide, polyimide, polyamideimide, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinyl pyrrolidone, polyether, polyether sulfone, hexafluoropolypropylene, a styrene-butadiene rubber, and carboxymethyl cellulose. Examples of the binder also include copolymers of two or more materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethylvinyl ether, acrylic acid, and hexadiene. Two or more selected from these may be combined with each other to be used as the binder.

At least one selected from the group consisting of the positive electrode layer 520 and the negative electrode layer 540 may contain a conductive additive for the purpose of enhancing electron conductivity. Examples of the conductive additive include graphite such as natural graphite and artificial graphite; carbon black such as acetylene black and Ketjen black; conductive fibers such as carbon fiber and metal fiber; metal powders such as carbon fluoride and aluminum; conductive whiskers such as zinc oxide and potassium titanate; conductive metal oxides such as titanium oxide; and conductive polymer compounds such as polyaniline, polypyrrole, and polythiophene. When a carbon conductive additive is used, costs can be reduced.

As another example, the power generating device 5000 may be formed of a plurality of power generating elements laminated on each other.

The power generating elements may be, for example, connected to each other in series. Connecting the power generating elements to each other in series can improve battery voltage. Alternatively, the power generating elements may be, for example, connected to each other in parallel. Connecting the power generating elements to each other in parallel can improve battery capacity. In accordance with the application in which the battery is used, the number of them to be connected and the method for connecting them to each other can be appropriately selected.

The power generating device 5000 may be one formed by bipolar-laminating power generating elements in series. Bipolar lamination refers to a positive electrode layer and a negative electrode layer of an adjacent power generating element being connected to each other with a bipolar collector solely functioning as both a positive electrode collector and a negative electrode collector. Using the bipolar collector can reduce the volume of the collector in the battery and can increase battery energy density.

The space between the covering body 1000 and drawing parts of the positive electrode terminal and the negative electrode terminal may be sealed with resin or the like.

The battery according to the present disclosure can be used, for example, as an all-solid lithium-ion secondary battery.

What is claimed is:

1. A battery comprising:
a power generator; and
a covering body covering the power generator, wherein
the power generator includes:
a positive electrode layer;
a negative electrode layer; and
a solid electrolyte layer positioned between the positive electrode layer and the negative electrode layer,
at least one selected from the group consisting of the positive electrode layer, the solid electrolyte layer, and the negative electrode layer contains a halogen-containing solid electrolyte,
the covering body includes:
a base material layer;
a resin layer; and
a metal layer positioned between the base material layer and the resin layer, and
the resin layer is disposed so as to face the power generator and contains a halogen-containing polymer.

2. The battery according to claim 1, wherein the metal layer contains at least one selected from the group consisting of aluminum, an aluminum alloy, and stainless steel.

3. The battery according to claim 1, wherein the metal layer contains aluminum.

4. The battery according to claim 1, wherein an ion radius of halogen contained in the resin layer is equal to or smaller than an ion radius of halogen contained in the solid electrolyte.

5. The battery according to claim 1, further comprising a primer layer positioned between the metal layer and the resin layer.

6. The battery according to claim 5, wherein the primer layer contains at least one selected from the group consisting of nitrogen, silicon, sulfur, and titanium.

7. The battery according to claim 5, wherein the primer layer contains at least one selected from the group consisting of a silane coupling agent, a titanate coupling agent, polyimide, polyimide, and a polymer having a sulfonic acid group.

8. The battery according to claim 1, wherein the resin layer further contains a polymer containing no halogen.

9. The battery according to claim 1, wherein the halogen-containing polymer is a polymer containing fluorine atoms or chlorine atoms.

10. The battery according to claim 9, wherein
the halogen-containing polymer is a fluorine-containing polymer, and
the fluorine-containing polymer contains at least one selected from the group consisting of tetrafluoroethylene, vinylidene fluoride, perfluoroalkyl vinyl ether, hexafluoropropylene, and chlorotrifluoroethylene.

11. The battery according to claim 9, wherein
the halogen-containing polymer is a fluorine-containing polymer, and
the fluorine-containing polymer contains at least one selected from the group consisting of tetrafluoroethylene, vinylidene fluoride, and hexafluoropropylene.

12. The battery according to claim 9, wherein
the halogen-containing polymer is a fluorine-containing polymer, and
the fluorine-containing polymer contains at least one selected from the group consisting of fluorinated polyethylene, fluorinated polypropylene, poly(tetrafluoroethylene-co-hexafluoropropylene), polytetrafluoroethylene, polyvinylidene fluoride, polyvinyl fluoride, polychlorotrifluoroethylene, a fluorine rubber, a fluorosilicone rubber, poly(vinylidene fluoride-co-hexafluoropropylene), poly(vinylidene fluoride-co-hexafluoropropylene-co-tetrafluoroethylene), a tetrafluoroethylene-propylene rubber, and a tetrafluoroethylene-perfluoromethylvinyl ether rubber.

13. The battery according to claim 1, wherein a concentration of halogen of the resin layer becomes higher continuously or in stages from a side facing the metal layer toward a side facing away from the metal layer.

14. A battery covering body comprising:
a base material layer;
a resin layer; and
a metal layer positioned between the base material layer and the resin layer, wherein
the resin layer contains a halogen-containing polymer.

15. The battery covering body according to claim 14, further comprising a primer layer positioned between the metal layer and the resin layer.

16. The battery covering body according to claim 14, wherein the metal layer contains aluminum.

17. The battery covering body according to claim 14, wherein the halogen-containing polymer is a polymer containing fluorine atoms or chlorine atoms.

18. The battery covering body according to claim 17, wherein
the halogen-containing polymer is a fluorine-containing polymer, and
the fluorine-containing polymer contains at least one selected from the group consisting of tetrafluoroethylene, vinylidene fluoride, perfluoroalkyl vinyl ether, hexafluoropropylene, and chlorotrifluoroethylene.

19. The battery covering body according to claim 17, wherein
the halogen-containing polymer is a fluorine-containing polymer, and
the fluorine-containing polymer contains at least one selected from the group consisting of tetrafluoroethylene, vinylidene fluoride, and hexafluoropropylene.

20. The battery covering body according to claim 17, wherein
the halogen-containing polymer is a fluorine-containing polymer, and
the fluorine-containing polymer contains at least one selected from the group consisting of fluorinated polyethylene, fluorinated polypropylene, poly(tetrafluoroethylene-co-hexafluoropropylene), polytetrafluoroethylene, polyvinylidene fluoride, polyvinyl fluoride, polychlorotrifluoroethylene, a fluorosilicone rubber, poly(vinylidene fluoride-co-hexafluoropropylene), poly(vinylidene fluoride-co-hexafluoropropylene-co-tetrafluoroethylene), a tetrafluoroethylene-propylene rubber, and a tetrafluoroethylene-perfluoromethylvinyl ether rubber.
